(19) United States
(12) Patent Application Publication
(10) Pub. No.: US 2013/0110594 A1
(43) Pub. Date: May 2, 2013

(54) AD COPY DETERMINATION

(71) Applicants: Aleksey Sinyagin, Bothell, WA (US); Sameer Abrol, Bothell, WA (US); Victor Carl Mamich, JR., Bellevue, WA (US)

(72) Inventors: Aleksey Sinyagin, Bothell, WA (US); Sameer Abrol, Bothell, WA (US); Victor Carl Mamich, JR., Bellevue, WA (US)

(73) Assignee: MICROSOFT CORPORATION, Redmond, WA (US)

(21) Appl. No.: 13/284,327

(22) Filed: Oct. 28, 2011

(51) Int. Cl. G06Q 30/02

(52) U.S. Cl. 705/14.6; 705/14.49

(57) ABSTRACT

One or more target web page documents that include web page content may be obtained. Text content associated with the web page content may be determined. One or more candidate web advertisements may be generated, via a device processor, based on an analysis of the determined text content.

### BACKGROUND

Users of electronic devices are increasingly relying on information obtained from the Internet as sources of news reports, ratings, descriptions of items, announcements, event information, and other various types of information that may be of interest to the users. Further, users are increasingly relying on advertisements that may appear on web pages such as search results to provide information that may be of interest with regard to their purchasing interests. Vendors may wish to arrange for advertisements of their services or products to appear as additional information to users who may be viewing or searching for particular types of items.

Advertising services may provide tools for vendors to create their own advertisements, and may offer subscriptions for advertising campaigns. For example, an advertising service may charge vendors a fee for user clicks on vendor advertisements (e.g., clicks by users to view further information introduced by the advertisement. For example, a user may enter keywords or search objects into a search engine, and vendor advertisements may appear on result pages.

### SUMMARY

According to one general aspect, a system may include a document acquisition component that obtains one or more web page documents. The system may also include a page parsing component that extracts display text from the obtained one or more web page documents. The system may also include an advertisement candidate generator component that generates, via a device processor, one or more candidate advertisements based on the extracted display text, based on an analysis of language model attributes and historical advertising success attributes associated with the extracted display text.

According to another aspect, one or more target web page documents that include web page content may be obtained. Text content associated with the web page content may be determined. One or more candidate web advertisements may be generated, via a device processor, based on an analysis of the determined text content.

According to another aspect, a computer program product tangibly embodied on a computer-readable storage medium may include executable code that may cause at least one data processing apparatus to obtain a location indicator associated with one or more target web page documents that include web page content. Further, the at least one data processing apparatus may initiate, via a device processor, a request for one or more candidate web advertisements based on an analysis of the web page content included in the one or more target web page documents. Further, the at least one data processing apparatus may initiate a display of the one or more candidate web advertisements.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings, and from the claims.

### DRAWINGS

FIG. 1 is a block diagram of an example system for advertisement determination.

FIG. 2 is a flowchart illustrating example operations of the system of FIG. 1.

FIG. 3 is a flowchart illustrating example operations of the system of FIG. 1.

FIG. 4 is a flowchart illustrating example operations of the system of FIG. 1.

FIG. 5 depicts an example taxonomy based on ad copy text considerations.

FIG. 6 is a block diagram of an example system for advertisement determination.

FIG. 7 depicts an example decision tree.

FIG. 8 depicts an example user interface for user input to the system of FIG. 1.

FIG. 9 depicts an example user interface for displaying advertisement previews to the user.

### DETAILED DESCRIPTION

Advertising services may provide tools for vendors to create their own advertisements, and may offer subscriptions for advertising campaigns. The advertising services may wish to aid vendors in achieving successful advertising campaigns (e.g., high rate of user clicks on advertisements, and high rate of user follow-through based on resulting purchases). The advertising services may wish to place advertisements with highest probabilities of user activity in web page locations where the user is most likely to read the advertisements. For example, advertisements may be placed adjacent to, or intermixed in, the top level of search results (e.g., most likely to be read), or they may be placed at the bottom of search results pages, or on pages after the first page of search results. As another example, the advertisements may be placed in one position, with timed shuffling of advertisements placed in a small, prominent location on the page.

Such advertisements may be subject to space limitations (e.g., 30 characters for a title, and 70 characters for a text body). Therefore, a vendor may wish to determine how to describe their product or service in as few words (or characters, or other web page objects) as possible, using high quality descriptive terms (or other web page objects) that provide high appeal to the users viewing the advertisements. The vendors may have one or more established web page documents describing their business and/or products, and providing tools for making purchases. Thus, the advertisements may include links to the established web pages, after obtaining the users' interest via the short advertisement.

Further, the vendors may wish to avoid paying for advertisements that are not likely to lead to purchases by particular users. Thus, the vendors may wish to stifle display of their advertisements to users who are likely to not wish to view the advertisements and subsequently make purchases. For example, a user entering a search term “vegan” may not be likely to purchase several pounds of prime rib beef form a vendor of meat products.

Example techniques discussed herein may provide advertisements based on a user's target web page document (or one or more target web page documents associated with a target web site). Example techniques discussed herein may provide advertisements further based on a user's additional input. Example techniques discussed herein may provide advertisements based on statistical information that is based on language models that may be based on a corpus of text information accumulated via crawls of the Internet, and on statistical information that is based on advertisements that may be based on a corpus of advertisements that may be sponsored by one or more advertising services. Example web pages may include text or other web page objects such as image files, audio files, or other files indicating sensory effects.

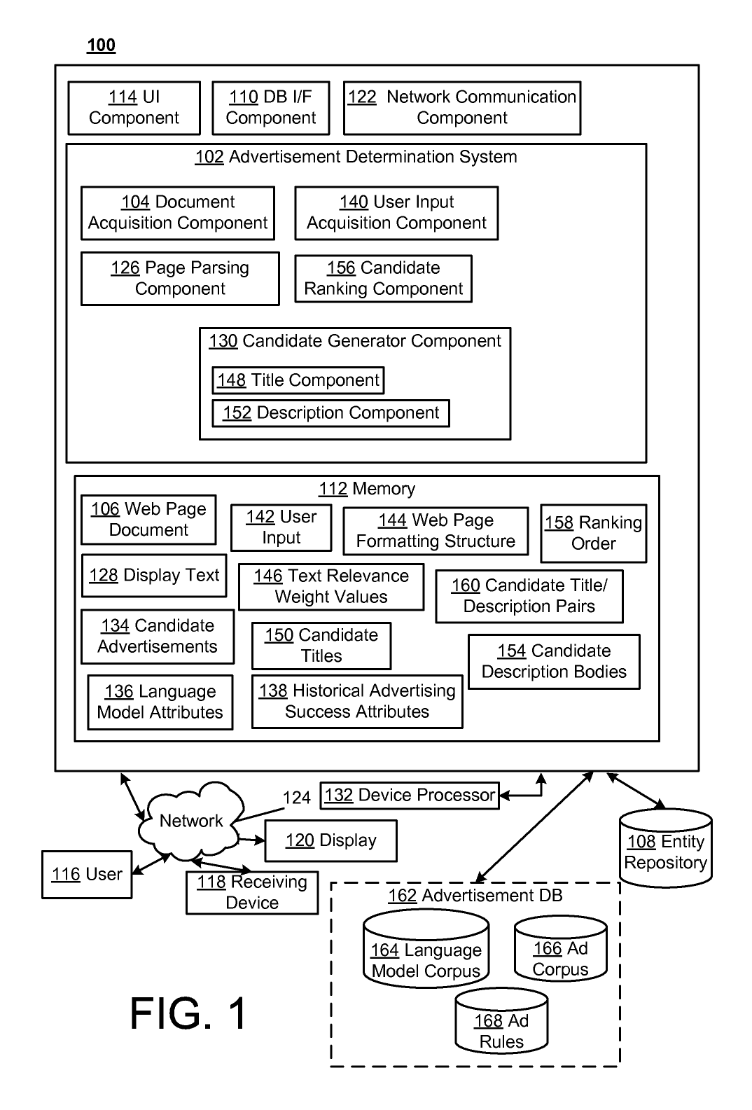

As further discussed herein, FIG. 1 is a block diagram of a system 100 for candidate advertisement determination. As shown in FIG. 1, a system 100 may include an advertisement determination system 102 that includes a document acquisition component 104 that may obtain one or more web page documents 106. For example, the one or more web page documents 106 may include one or more documents that are accessible on the Internet. For example, the document acquisition component 104 may obtain the one or more web page documents 106 based on a target location indicator provided by a user (e.g., providing a Uniform Resource Locator (URL) or an Internet Protocol (IP) address).

According to an example embodiment, the advertisement determination system 102 may include executable instructions that may be stored on a computer-readable storage medium, as discussed below. According to an example embodiment, the computer-readable storage medium may include any number of storage devices, and any number of storage media types, including distributed devices.

For example, an entity repository 108 may include one or more databases, and may be accessed via a database interface component 110. One skilled in the art of data processing will appreciate that there are many techniques for storing repository information discussed herein, such as various types of database configurations (e.g., SQL SERVERS) and non-database configurations.

According to an example embodiment, the advertisement determination system 102 may include a memory 112 that may store the one or more web page documents 106. In this context, a “memory” may include a single memory device or multiple memory devices configured to store data and/or instructions. Further, the memory 112 may span multiple distributed storage devices.

According to an example embodiment, a user interface component 114 may manage communications between a user 116 and the advertisement determination system 102. The user 116 may be associated with a receiving device 118 that may be associated with a display 120 and other input/output devices. For example, the display 120 may be configured to communicate with the receiving device 118, via internal device bus communications, or via at least one network connection.

According to an example embodiment, the advertisement determination system 102 may include a network communication component 122 that may manage network communication between the advertisement determination system 102 and other entities that may communicate with the advertisement determination system 102 via at least one network 124. For example, the at least one network 124 may include at least one of the Internet, at least one wireless network, or at least one wired network. For example, the at least one network 124 may include a cellular network, a radio network, or any type of network that may support transmission of data for the advertisement determination system 102. For example, the network communication component 122 may manage network communications between the advertisement determination system 102 and the receiving device 118. For example, the network communication component 122 may manage network communication between the user interface component 114 and the receiving device 118.

A page parsing component 126 may extract display text 128 from the obtained one or more web page documents 106. For example, the display text 128 may include text that may be displayed to a user as part of an advertising campaign. According to an example embodiment, the page parsing component 126 may extract metadata associated with the one or more web page documents 106.

An advertisement candidate generator component 130 may generate, via a device processor 132, one or more candidate advertisements 134 based on the extracted display text 128, based on an analysis of language model attributes 136 and historical advertising success attributes 138 associated with the extracted display text 128, as discussed further below. For example, the language model attributes 136 may include attributes associated with contextual language usage and grammar. For example, the historical advertising success attributes 138 may include historical information associated with numbers of user clicks associated with user accesses to advertisements that may include (or not include) particular text strings. For example, the historical advertising success attributes 138 may include historical information associated with numbers of follow-through transactions (e.g., purchases resulting from user clicks on advertisements).

In this context, a “processor” may include a single processor or multiple processors configured to process instructions associated with a processing system. A processor may thus include multiple processors processing instructions in parallel and/or in a distributed manner. Although the device processor 132 is depicted as external to the advertisement determination system 102 in FIG. 1, one skilled in the art of data processing will appreciate that the device processor 132 may be implemented as a single component, and/or as distributed units which may be located internally or externally to the advertisement determination system 102, and/or any of its elements.

According to an example embodiment, a user input acquisition component 140 may obtain input 142 from a user. For example, the user 116 may input information that he/she may wish to contribute as explanation of his/her goals in an advertisement (e.g., advertising a particular service or commodity such as an automobile). For example, the user 116 may enter keywords or other web page objects that he/she may deem relevant to a particular advertisement. For example, the user may enter keywords (or objects) for searches that the potential customer may enter for search engines. For example, the user 116 may provide both positive and negative keywords that potential customers may enter for search engines. In this context, a “negative keyword” may include a keyword for which the user 116 may not want his/her advertisement displayed as potential customers perform search on those keywords. For example, if the user 116 is a vendor of meat products, then he/she may provide “vegan” (or an image file associated with a vegetable) as a negative keyword (e.g., as an indicator that the user 116 would prefer that his/her “meat product” advertisement not be displayed to potential customers searching the term “vegan”).

According to an example embodiment, the advertisement candidate generator component 130 may generate the one or more candidate advertisements 134 based on the extracted display text 128 and the obtained input 142 from the user, based on an analysis of language model attributes 136 and historical advertising success attributes 138 associated with the extracted display text 128 and the obtained input 142 from the user. For example, the advertisement candidate generator component 130 may generate the candidate advertisements 134 based on language model attributes 136 associated with frequencies of usage of n-grams, frequencies of usage of n-grams in particular contexts, spelling usage, usage of consecutive grammatical items (e.g., consecutive prepositions), punctuation (e.g., exclamation points), capitalization (e.g., words in all capital letters), slang usage, and other attributes.

For example, the advertisement candidate generator component 130 may generate the candidate advertisements 134 based on location information that may be derived from sources such as the extracted display text 128 and the obtained input 142 from the user, and other sources, as discussed further below. For example, the candidate generator component 130 may include location information in display text of the candidate advertisements 134, and/or may include location information in advertisement metadata so that a particular advertisement may be displayed to a potential customer who is currently or historically associated with a particular geographic location (e.g., via Global Positioning System (GPS) coordinates, geographical point triangulation, or Internet Protocol (IP) address).

For example, the advertisement candidate generator component 130 may generate the candidate advertisements 134 based on n-grams that may be related to n-grams included in the extracted display text 128 and the obtained input 142 from the user (e.g., as synonyms or antonyms). For example, a synonymous n-gram may be included in an advertisement due to advertisement length considerations, or based on an analysis indicating that the synonymous n-gram is associated with a history of greater advertising success than other n-grams (e.g., alone or in context).

For example, the advertisement candidate generator component 130 may generate the candidate advertisements 134 based on historical advertising success attributes 138 such as click through rates (CTRs), based on numbers of advertisements that receive user clicks for advertisements that include (or do not include) particular keywords or text strings (or particular web page objects). For example, the CTRs may be based on keyword-advertisement pairs (e.g., search keyword entered paired with advertisements that receive clicks in conjunction with the keyword search, or object search), frequency of clicks associated with ads that include particular n-grams, and other attributes.

According to an example embodiment, the page parsing component 126 may extract display text 128 from the obtained one or more web page documents 106 based on a web page formatting structure 144, and based on determining one or more text relevance weight values 146 based on the web page formatting structure 144 associated with the obtained one or more web page documents 106. According to an example embodiment, the advertisement candidate generator component 130 may generate the one or more candidate advertisements 134 based on the extracted display text 128, based at least in part on the one or more text relevance weight values 146.

According to an example embodiment, the web page formatting structure 144 includes one or more of HyperText Markup Language (HTML) or eXtensible Markup Language (XML) formatting. For example, the HTML tags or XML tags may be used to determine the text relevance weight values 146. Further, the web page formatting structure 144 may be used to determine text strings that may be intended as independent phrases (e.g., sentences terminated by periods, semicolons, line breaks) included in the one or more web page documents 106.

According to an example embodiment, the advertisement candidate generator component 130 may include an advertisement title component 148 that may determine one or more candidate titles 150 for advertisements based on the extracted display text 128. For example, the candidate titles 150 may be determined based on title length considerations, as well as analyses with regard to the language model attributes and historical advertising success attributes associated with the extracted display text.

According to an example embodiment, the advertisement candidate generator component 130 may include an advertisement description component 152 that may determine one or more candidate description bodies 154 for advertisements based on the extracted display text 128. For example, the candidate description bodies 154 may be determined based on description length considerations, as well as analyses with regard to the language model attributes and historical advertising success attributes associated with the extracted display text.

According to an example embodiment, the advertisement candidate generator component 130 may include an advertisement candidate ranking component 156 that may determine a ranking order 158 of pairs 160 of the candidate titles 150 and candidate description bodies 154, based on a ranking analysis of language model attributes 136 and historical advertising success attributes 138 associated with text included in the pairs 160 of candidate titles 150 and candidate description bodies 154.

According to an example embodiment, an advertisement database 162 may include a language model corpus 164 and an advertisement corpus 166. For example, the language model corpus 164 may include large amounts of text accumulated based on crawling the Internet and storing text discovered in web documents. For example, the advertisement database 162 may include text accumulated based on advertisements included in an advertising system, or based on crawling the Internet and storing text discovered in web documents. For example, the text stored in the language model corpus 164 may be processed and stored in an n-gram format, in lieu of storing all the text.

According to an example embodiment, the advertisement database 162 may include information associated with attributes associated with observed success and failure of text associated with advertisements. According to an example embodiment, the advertisement database 162 may include information associated with attributes associated with frequencies of n-grams in contexts of text strings, as discussed further below.

In this context, “tokens” may refer to smallest atomic units (e.g., elements) of data. For example, a token may include a single word of a language, or a single character of an alphabet. For example, a token may include a phrase included in a corpus based on phrases, or a word in a corpus based on words.

In this context, an “n-gram” may refer to a sequence of n sequential tokens. For example, an n-gram may include a sequence of units drawn from a longer sequence. For example, the sequence may include text, and a unit may include a word or a character of an alphabet. According to an example embodiment, statistical n-gram models, may be used to estimate a probability of each word in a text string based on the n−1 preceding words by utilizing the language model corpus 164 and the advertisement corpus 166 as training data.

According to an example embodiment, the advertisement database 162 may include a set of advertisement rules 168, as discussed further below. According to an example embodiment, the set of advertisement rules 168 may be dynamically updated, in accordance with variations in attributes associated with the language model corpus 164 and the advertisement corpus 166, as discussed further below. For example, a keyword (or search object) may be associated with a high CTR value on a particular day, but may be associated with a low CTR value one week later. For example, a sports team may achieve a first place ranking in a league one week, and may fall in the ratings the next week, which may affect popularity of advertising for league franchise merchandise associated with that team.

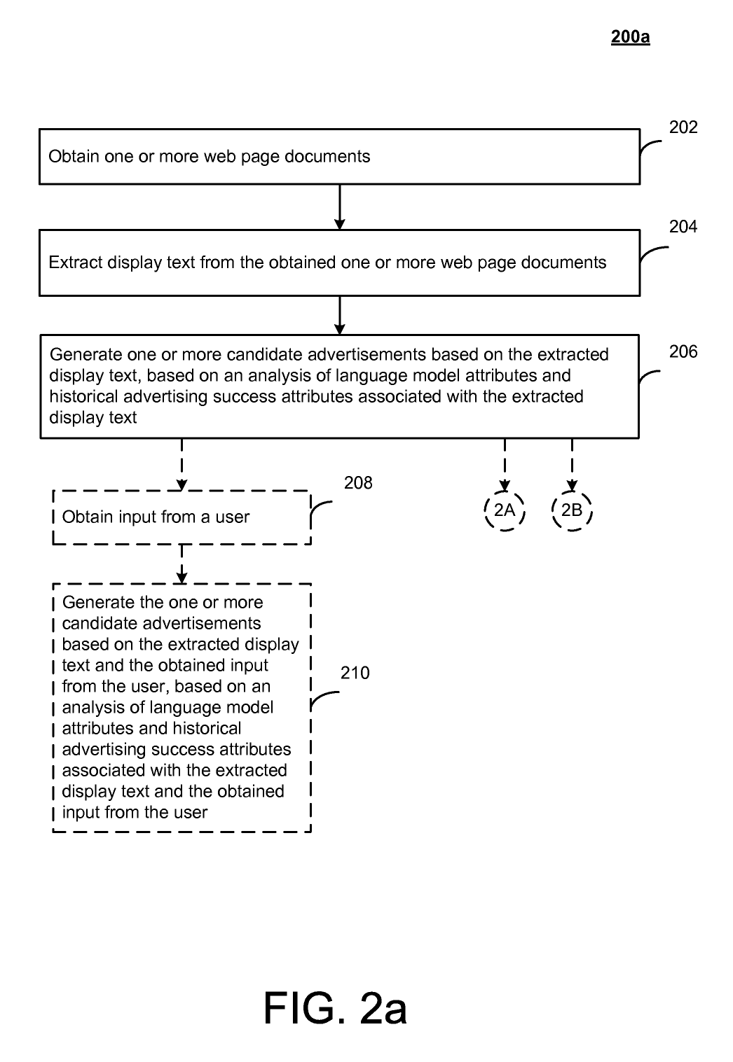

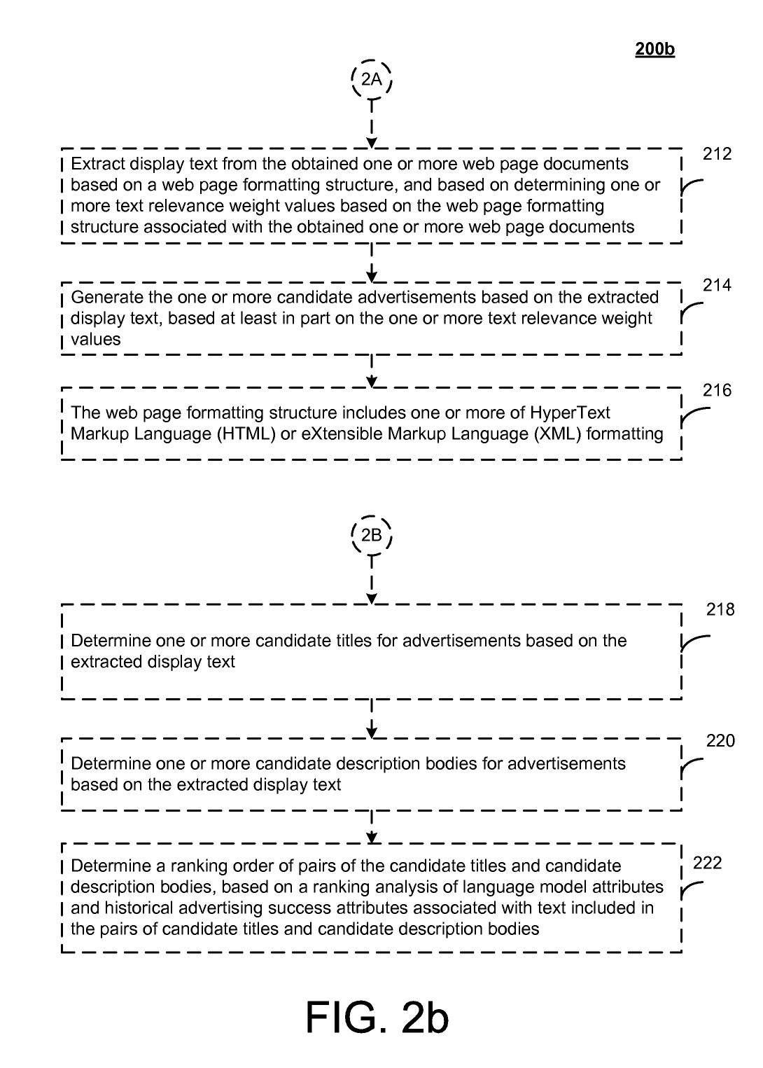

FIG. 2 is a flowchart illustrating example operations of the system of FIG. 1, according to example embodiments. In the example of FIG. 2a, one or more web page documents may be obtained (202). For example, the document acquisition component 104 may obtain the one or more web page documents 106, as discussed above.

Display text may be extracted from the obtained one or more web page documents (204). For example, the page parsing component 126 may extract display text 128 from the obtained one or more web page documents 106, as discussed above.

One or more candidate advertisements may be generated based on the extracted display text, based on an analysis of language model attributes and historical advertising success attributes associated with the extracted display text (206). For example, the advertisement candidate generator component 130 may generate, via the device processor 132, one or more candidate advertisements 134 based on the extracted display text 128, based on an analysis of language model attributes 136 and historical advertising success attributes 138 associated with the extracted display text 128, as discussed above.

According to an example embodiment, input may be obtained from a user a user (208). For example, the input acquisition component 140 may obtain input 142 from a user, as discussed above.

According to an example embodiment, the one or more candidate advertisements may be generated based on the extracted display text and the obtained input from the user, based on an analysis of language model attributes and historical advertising success attributes associated with the extracted display text and the obtained input from the user (210). For example, the advertisement candidate generator component 130 may generate the one or more candidate advertisements 134 based on the extracted display text 128 and the obtained input 142 from the user, based on an analysis of language model attributes 136 and historical advertising success attributes 138 associated with the extracted display text 128 and the obtained input 142 from the user, as discussed above.

According to an example embodiment, display text may be extracted from the obtained one or more web page documents based on a web page formatting structure, and based on determining one or more text relevance weight values based on the web page formatting structure associated with the obtained one or more web page documents (212). For example, the page parsing component 126 may extract the display text 128 from the obtained one or more web page documents 106 based on the web page formatting structure 144, and based on determining one or more text relevance weight values 146 based on the web page formatting structure 144 associated with the obtained one or more web page documents 106, as discussed above.

According to an example embodiment, the one or more candidate advertisements may be generated based on the extracted display text, based at least in part on the one or more text relevance weight values (214). According to an example embodiment, the web page formatting structure may include one or more of HyperText Markup Language (HTML) or eXtensible Markup Language (XML) formatting (216).

According to an example embodiment, one or more candidate titles for advertisements may be determined based on the extracted display text (218). For example, the advertisement title component 148 may determine one or more candidate titles 150 for advertisements based on the extracted display text 128, as discussed above.

According to an example embodiment, one or more candidate description bodies for advertisements may be determined based on the extracted display text (220). For example, the advertisement description component 152 may determine one or more candidate description bodies 154 for advertisements based on the extracted display text 128, as discussed above.

According to an example embodiment, a ranking order of pairs of the candidate titles and candidate description bodies may be determined, based on a ranking analysis of language model attributes and historical advertising success attributes associated with text included in the pairs of candidate titles and candidate description bodies (222). For example, the advertisement candidate ranking component 156 may determine a ranking order 158 of pairs 160 of the candidate titles 150 and candidate description bodies 154, based on a ranking analysis of language model attributes 136 and historical advertising success attributes 138 associated with text included in the pairs 160 of candidate titles 150 and candidate description bodies 154, as discussed above.

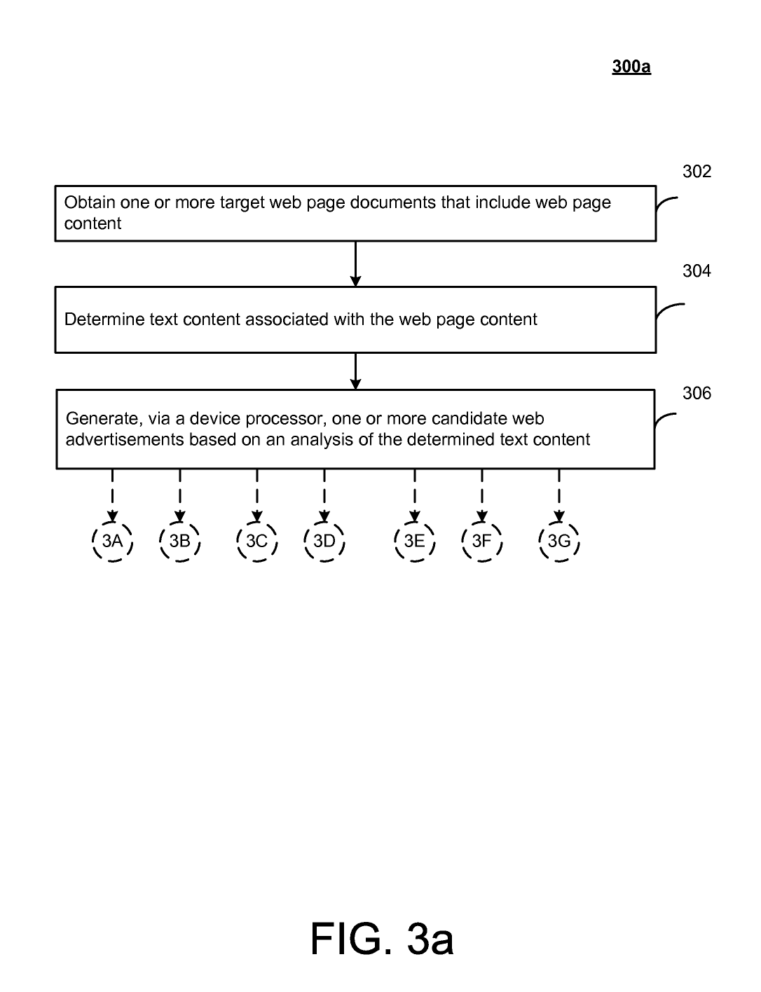

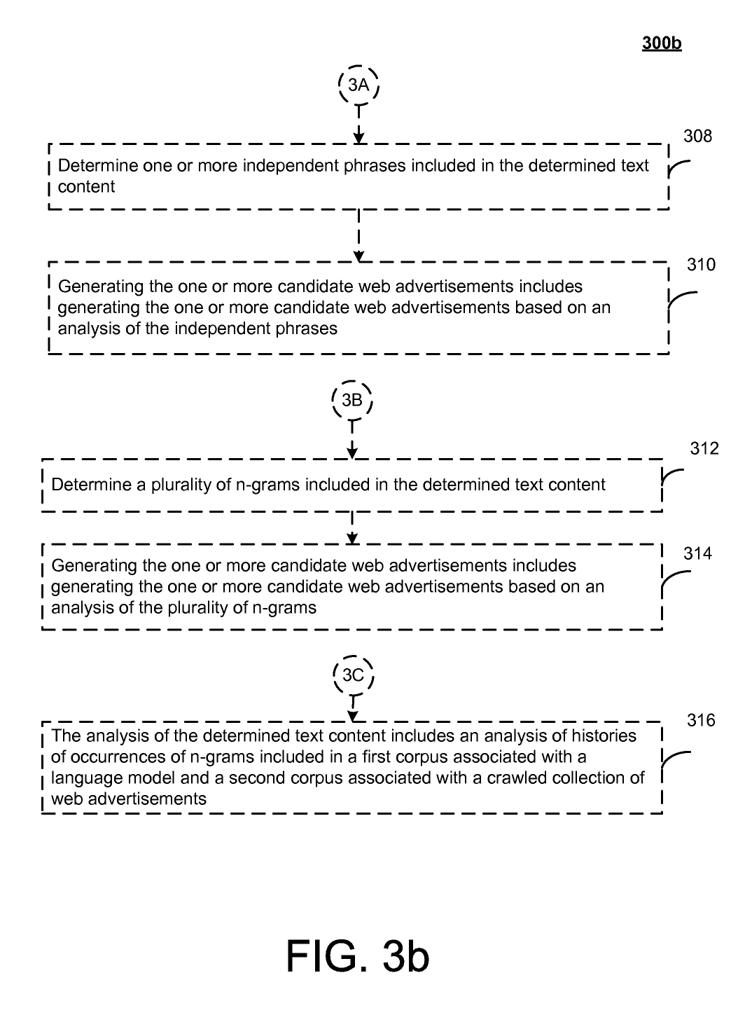

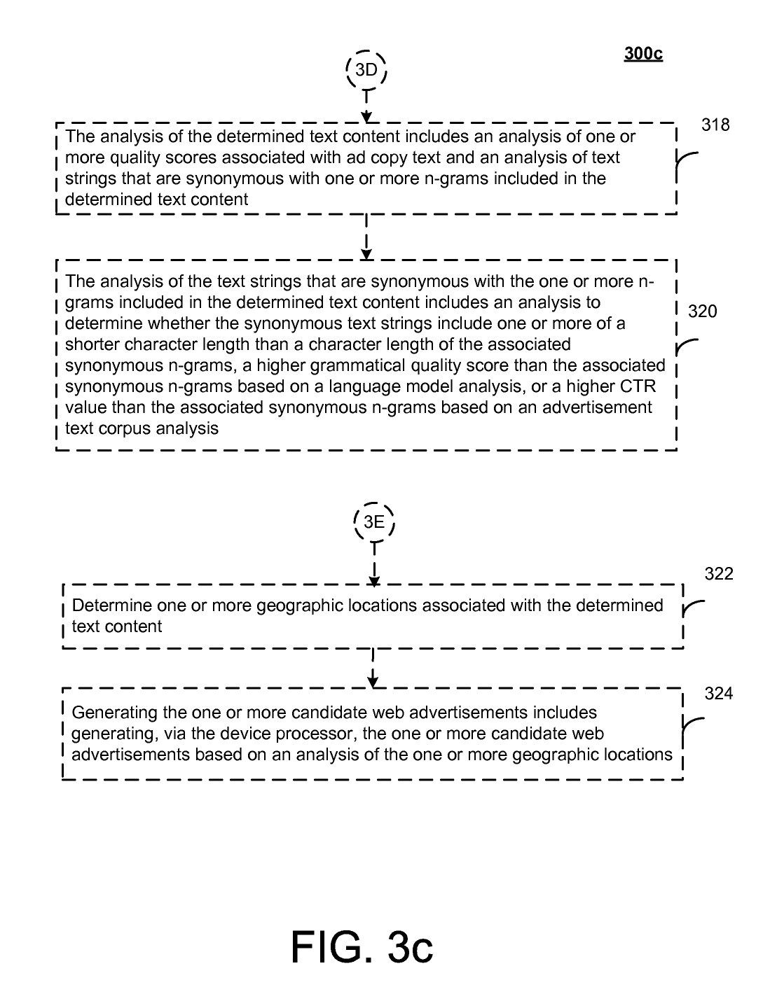

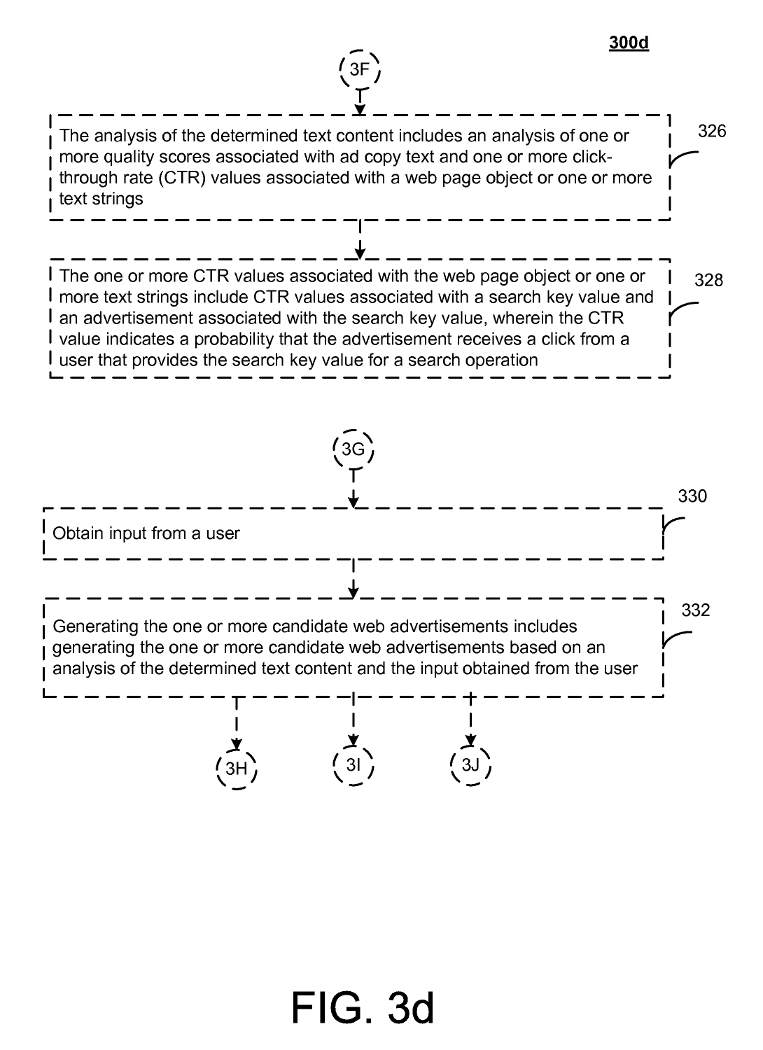

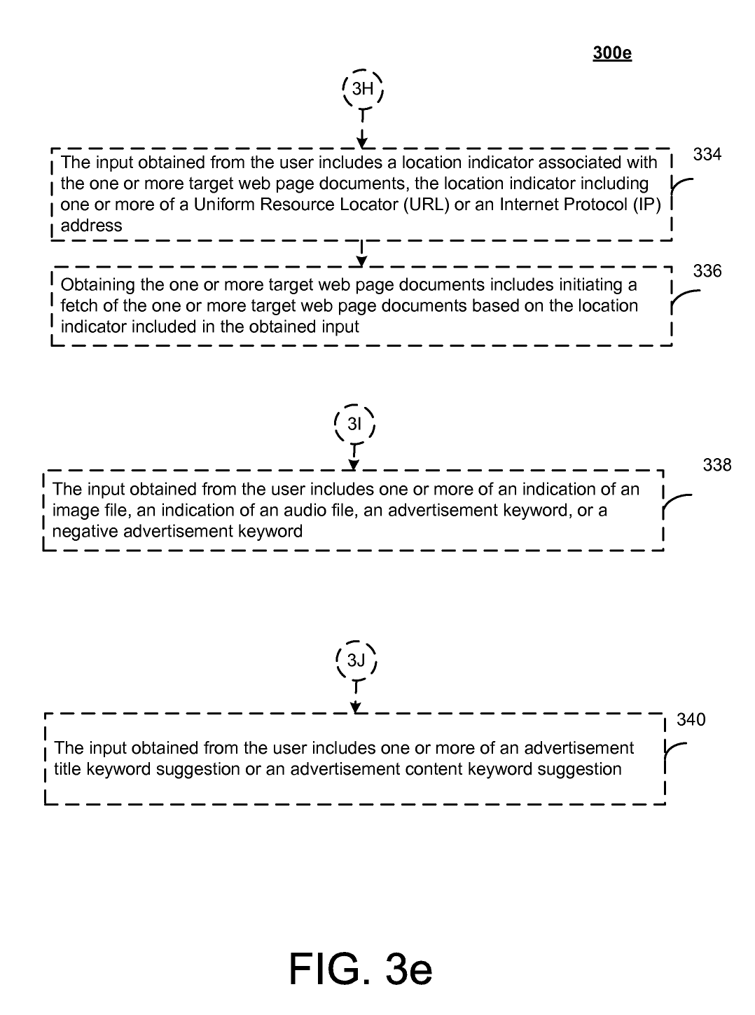

FIG. 3 is a flowchart illustrating example operations of the system of FIG. 1, according to example embodiments. In the example of FIG. 3a, one or more target web page documents that include web page content may be obtained (302). For example, the document acquisition component 104 may obtain the one or more web page documents 106, as discussed above.

Text content associated with the web page content may be determined (304). For example, the page parsing component 126 may extract display text 128 from the obtained one or more web page documents 106, as discussed above. For example, text content associated with one or more web page objects (e.g., image files, audio files) may be determined, e.g., via the page parsing component 126.

One or more candidate web advertisements may be generated based on an analysis of the determined text content (306). For example, the advertisement candidate generator component 130 may generate, via the device processor 132, one or more candidate advertisements 134 based on the determined text (e.g., text 128), based on an analysis of the determined text.

According to an example embodiment, one or more independent phrases included in the determined text content may be determined (308). For example, the page parsing component 126 may determine one or more independent phrases included in the display text content 128 discussed above. For example, the independent phrases may include sentences (e.g., terminated by periods, semicolons, line breaks) included in the one or more web page documents 106, as discussed above.

According to an example embodiment, generating the one or more candidate web advertisements may include generating, via the device processor, the one or more candidate web advertisements based on an analysis of the independent phrases (310).

According to an example embodiment, a plurality of n-grams included in the determined text content may be determined (312). For example, the page parsing component 126 may determine the plurality of n-grams included in the determined text content.

According to an example embodiment, generating the one or more candidate web advertisements may include includes generating, via the device processor, the one or more candidate web advertisements based on an analysis of the plurality of n-grams (314).

According to an example embodiment, the analysis of the determined text content may include an analysis of histories of occurrences of n-grams included in a first corpus associated with a language model and a second corpus associated with a crawled collection of web advertisements (316). For example, the advertisement candidate generator component 130 may generate, via the device processor 132, one or more candidate advertisements 134 based on the determined text, based on an analysis of language model attributes 136 and historical advertising success attributes 138 associated with the determined text content, based on the language model corpus 164 and an advertisement corpus 166, as discussed above.

According to an example embodiment, the analysis of the determined text content may include an analysis of one or more quality scores associated with ad copy text and an analysis of text strings that are synonymous with one or more n-grams included in the determined text content (318). For example, the advertisement candidate generator component 130 may generate the candidate advertisements 134 based on quality scores (e.g., grammatical, spelling quality scores) and on n-grams that may be related to n-grams included in the determined text content and the obtained input 142 from the user, as discussed above.

According to an example embodiment, the analysis of the text strings that are synonymous with the one or more n-grams included in the determined text content may include an analysis to determine whether the synonymous text strings include one or more of a shorter character length than a character length of the associated synonymous n-grams, a higher grammatical quality score than the associated synonymous n-grams based on a language model analysis, or a higher CTR value than the associated synonymous n-grams based on an advertisement text corpus analysis (320). For example, the advertisement text corpus analysis may be based on the advertisement corpus 166, as discussed above.

According to an example embodiment, one or more geographic locations associated with the determined text content may be determined (322). For example, location information may be derived from sources such as the determined text content or obtained web page content (e.g., image files or audio files) and the obtained input 142 from the user, and other sources. For example, the candidate generator component 130 may include location information in web page content of the candidate advertisements 134, and/or may include location information in advertisement metadata so that a particular advertisement may be displayed to a potential customer who is currently or historically associated with a particular geographic location (e.g., via Global Positioning System (GPS) coordinates, geographical point triangulation, or Internet Protocol (IP) address).

According to an example embodiment, generating the one or more candidate web advertisements may include generating, via the device processor, the one or more candidate web advertisements based on an analysis of the one or more geographic locations (324). For example, if a location of a restaurant may be determined (based on the one or more web page documents 106, the user input 142, or other informational sources), then a text string (or other web page object) indicating the location may be included in a candidate web advertisement for the restaurant (e.g., if a location of a potential customer may be determined as close to the restaurant location). For example, location parameters may be included in the candidate web advertisements to provide dynamic location display based on potential customer activity.

According to an example embodiment, the analysis of the extracted display text content may include an analysis of one or more quality scores associated with ad copy text and one or more click-through rate (CTR) values associated with a web page object or one or more text strings (326).

According to an example embodiment, the one or more CTR values associated with the web page object or one or more text strings may include CTR values associated with a search key value and an advertisement associated with the search key value, wherein the CTR value indicates a probability that the advertisement receives a click from a user that provides the search key value for a search operation (328).

According to an example embodiment, input may be obtained from a user (330). For example, the user input acquisition component 140 may obtain input 142 from the user 116, as discussed above.

According to an example embodiment, generating the one or more candidate web advertisements may include generating, via the device processor, the one or more candidate web advertisements based on an analysis of the determined text content and the input obtained from the user (332). For example, the advertisement candidate generator component 130 may generate the one or more candidate advertisements 134 based on the determined text content and the obtained input 142 from the user 116, as discussed above.

According to an example embodiment, the input obtained from the user may include a location indicator associated with the one or more target web page documents, the location indicator including one or more of a Uniform Resource Locator (URL) or an Internet Protocol (IP) address (334).

According to an example embodiment, obtaining the one or more target web page documents may include initiating a fetch of the one or more target web page documents based on the location indicator included in the obtained input (336). For example, the document acquisition component 104 may obtain the one or more web page documents 106 based on the target location indicator provided by the user 116, as discussed above.

According to an example embodiment, the input obtained from the user may include one or more of an indication of an image file, an indication of an audio file, an advertisement keyword or a negative advertisement keyword (338). For example, a “negative keyword” may include a keyword for which the user 116 may not want his/her advertisement displayed as potential customers perform search on those keywords, as discussed above. For example, the candidate generator component 130 may include an advertisement keyword or a negative advertisement keyword in metadata associated with the candidate advertisements 134.

According to an example embodiment, the input obtained from the user may include one or more of an advertisement title keyword suggestion or an advertisement content keyword suggestion (340).

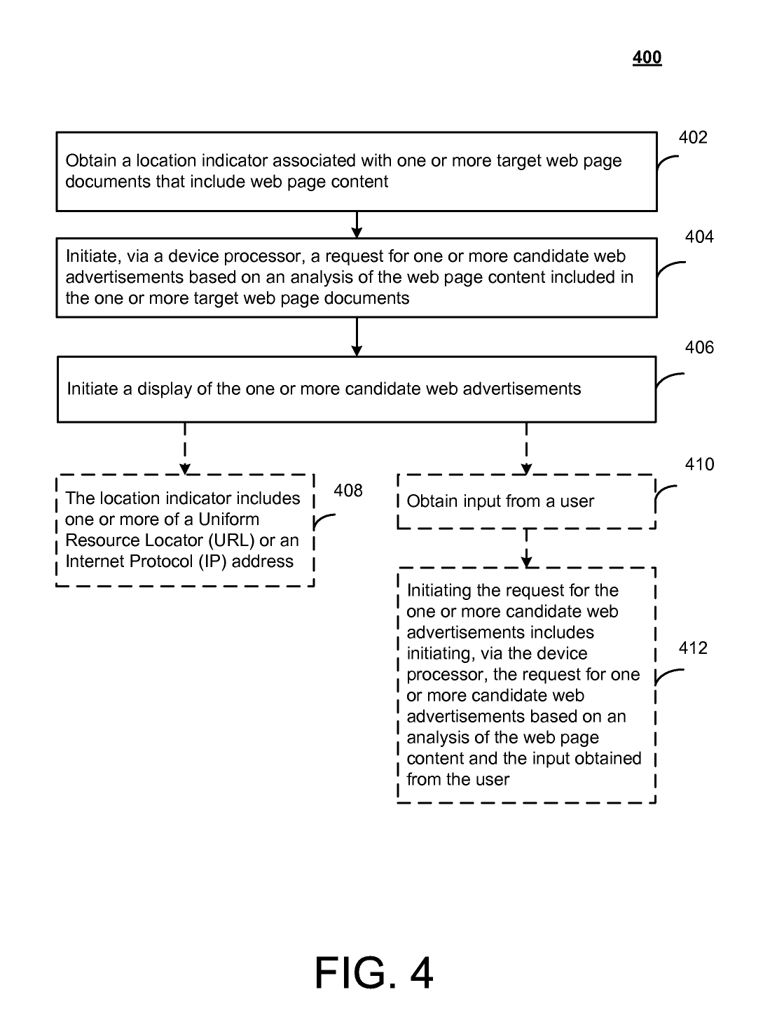

FIG. 4 is a flowchart illustrating example operations of the system of FIG. 1, according to example embodiments. In the example of FIG. 4, a location indicator associated with one or more target web page documents that include web page content may be obtained (402). For example, the location indicator may be obtained from a user (e.g., the user 116 associated with the receiving device 118 discussed above).

A request for one or more candidate web advertisements may be initiated, via a device processor, based on an analysis of the web page content included in the one or more target web page documents (404). For example, the receiving device 118 may initiate a request for the candidate web advertisements 134, based on input from the user 116.

A display of the one or more candidate web advertisements may be initiated (406). For example, the receiving device 118 may initiate the display of the candidate web advertisements 134 via the display 120.

According to an example embodiment, the location indicator may include one or more of a Uniform Resource Locator (URL) or an Internet Protocol (IP) address (408).

According to an example embodiment, input may be obtained from a user (410). For example, the receiving device 118 may receive the input 142 from the user 116.

According to an example embodiment, initiating, via the device processor, the request for one or more candidate web advertisements based on an analysis of the web page content and the input obtained from the user (412).

In advertising scenarios, click through rate (CTR) may be used to measure the performance of an online advertisement (ad) or ad group associated with an advertising campaign. A CTR value may be determined based on a ratio of a number of ad clicks divided by a number of ad impressions. CTR values have been used in research efforts directed to optimizing online advertisements with a goal of achieving maximum CTR values for ads. Several factors may affect user perception and contribute to CTR variations, such as ad wording, placing, color, layout, size, font style, relevance, etc.

However, advertisers may create new ads by describing the business, and may create meaningful and attractive advertisements that fit in one or two sentences, in attempts to attract users' attention. Many advertisers may thus run counter to one or more developed theories with regard to well-performing ads, and may generate low performance ads with low (or no) CTR values. For example, the advertisers may include capitalizations, misspellings, and/or exclamation marks in their ads, or may generate descriptive and vague ads that may be regarded by users as digital garbage which may be easily ignored by the users.

Further, due to the dynamic nature of the internet, user attention to advertising may shift frequently, which may quickly shift the status of high performance ads to low performance ads, which may benefit substantially from frequent revisions or updates. As a result, a significant number of advertisements may be displayed to the users, but may not be receiving user clicks, leading to low performing advertising campaigns and advertiser dissatisfaction.

While CTR values may provide indicators of campaign performance, many advertisers may further aspire to achieve maximal conversion rates for every ad click. In this context, a conversion rate may refer to a ratio of visitors who perform an advertiser's desired actions after, or while visiting, the advertiser's website. For example, such conversions may include an online purchase, a registration, a subscription, a referral, etc. Thus, it may be difficult for many advertisers to correlate ad snippets to conversion rates. This problem may be compounded due to the nature of web ads, as very limited space may be allotted for an ad title (e.g., less than 30 characters) and description (e.g., less than 70 characters), or for other web page objects such as image files or audio files.

Experimental results have indicated that ads with inappropriate case and grammatical errors tend to be associated with significantly lower CTR values. For example, experimental assessments have been performed to assess a correlation of ad copy quality with ad CTR values, based on ads with case imperfections (e.g., ad title or ad description with first two characters in lower case) or grammatical errors (e.g., ad title or ad description including two consecutive prepositions), compared to more general ads. As indicated in Table 1 below (indicating a correlation between ad copy quality and CTR values, based on experimental results), in aggregate, mainline (ML) ads that include inappropriate case and grammatical errors may tend to be associated with significantly lower CTR values.

TABLE 1

| | ML-1 | | ML-1 | ML-1 |
|---|---|---|---|---|
| Grammar | Impressions | Percentage | Clicks | CTR |
| All | 286,828,462 | 100% | 29,596,903 | 10.319% |
| Either AdTitle or | 23,813,207 | 8.30% | 2,137,198 | 8.975% |
| AdDescription | | | | |
| has first two | | | | |
| characters in | | | | |
| lowercase | | | | |
| Either AdTitle or | 123,394 | 0.04% | 7,400 | 5.997% |
| AdDescription | | | | |
| begins with or | | | | |
| includes 2 | | | | |
| prepositions in a | | | | |
| row (e.g., “of of”) | | | | |

In accordance with experiments based on an example similar correlation for mainline ad CTR values broken down by advertiser, similar results were indicated.

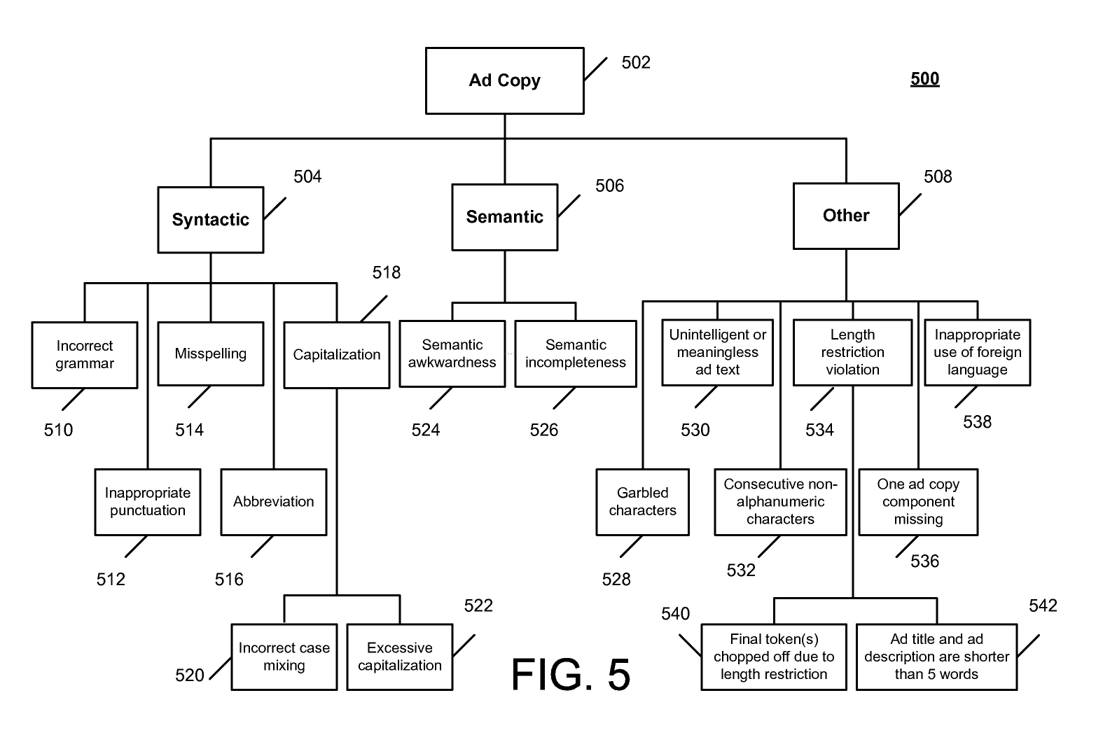

FIG. 5 depicts an example taxonomy based on ad copy text considerations, based on experimental results. As shown in FIG. 5, errors in ad copy text may be identified, for correction and for statistical purposes. An ad copy 502 element may include errors categorized as syntactic 504, semantic 506, or other 508.

The errors categorized as syntactic 504 may include incorrect grammar 510, inappropriate punctuation 512, misspelling 514, abbreviation 516, and capitalization 518. The errors categorized as capitalization 518 may include incorrect case mixing 520 and excessive capitalization 522.

The errors categorized as semantic 506 may include semantic awkwardness 524 and semantic incompleteness 526.

The errors categorized as other 508 may include garbled characters 528, unintelligent or meaningless ad text 530, consecutive non-alphanumeric characters 532, length restriction violation 534, one ad copy component missing 536, and inappropriate use of foreign language 538.

The errors categorized as length restriction violation 534 may include final token(s) chopped off due to length restriction 540 and ad title and ad description are shorter than 5 words 542.

Example techniques discussed herein may provide automatic, self-learning ad generation systems that may generate sets of candidate advertising snippets based on example techniques for maximizing probabilities of high CTR and conversion rates based on at least one learning corpus of historical data.

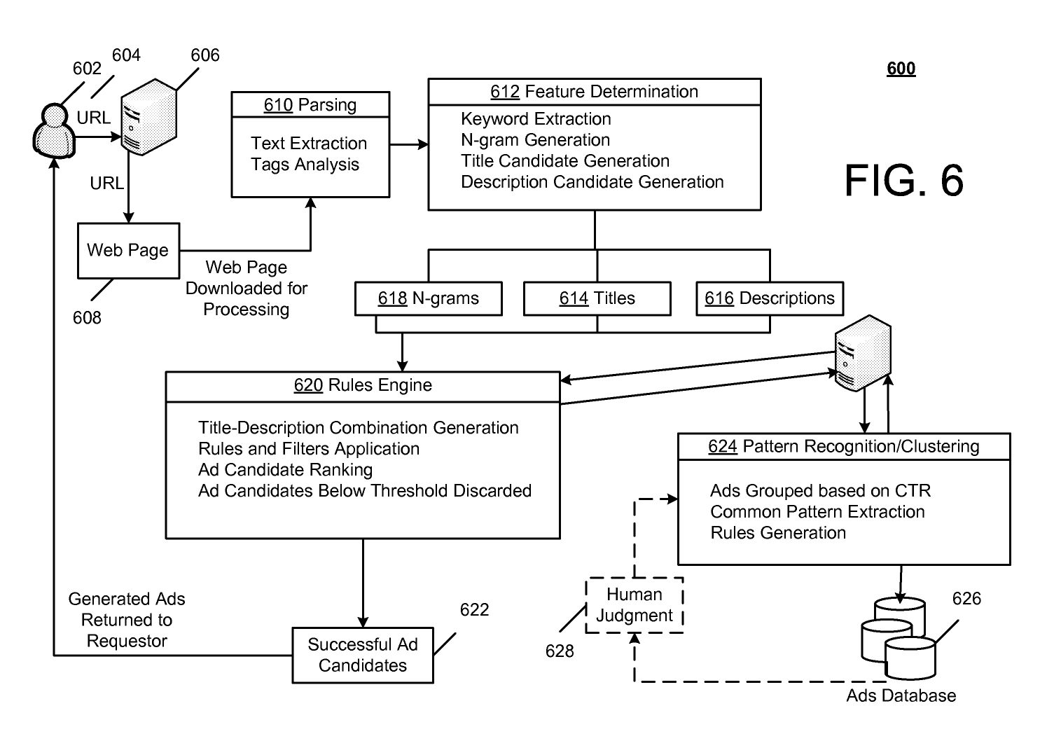

FIG. 6 is a block diagram of an example system for advertisement determination. As shown in FIG. 6, an example system 600 may include a real-time processing module and an offline rules generation system, as discussed further below.

The example real-time processing module of FIG. 6 may be implemented as a scalable module exposed as web service or as a redistributable package that may provide real-time parsing and processing of web document content (e.g., HTML content, XML content).

The real-time processing module of FIG. 6 may obtain input from a user 602 (e.g., the user 116 of FIG. 1). For example, the user 602 may input a URL 604 to a device 606. The URL 604 may be used to obtain a web page 608 (e.g., via fetching the document from the web). A parsing module 610 may parse text included in the web page (e.g., HTML text, XML text), and may provide weights to strings of text based on text relevance, based on a structure of the document (e.g., HTML structure).

A feature determination module 612 may extract candidate strings from the document for titles 614 and descriptions 616 for advertisement candidates. The feature determination module 612 may generate n-gram metadata 618 for use in generating the candidate strings, and to be passed to the next module.

A rules engine 620 may apply rules from a pre-generated rule set to rewrite generated snippets to include high score keywords and embed location aware parameters. The rules engine 620 may determine a ranking order of the pairs of generated title and description combinations to determine candidate ad copies, for example, based on discarding advertisement candidates that rank below a predetermined threshold value. The successful advertisements 622 may then be returned to the user 602.

As discussed above, the real-time processing module of FIG. 6 may extract snippets of text determined as most relevant text strings for consideration as candidates for ad titles and descriptions. Further, keywords and location information may be utilized in the candidates to maximize probabilities of user clicks on the advertisements.

As an example of a text rewrite, a snippet such as “Best Chicago style pizza!” may be rewritten to “Best deep dish pizza in Seattle” to embed more descriptive keywords and location identifiers in an advertisement title.

As discussed herein, example techniques may utilize an n-grams approach analyze the text. For example, an n-gram may include a sequence of units drawn from a longer sequence. For example, the sequence may include the extracted text, and the unit may include a word or a character of an alphabet. As further discussed herein, example techniques may utilize statistical n-gram models, which may estimate the probability of each word in a text string based on the N−1 preceding words by utilizing a crawled web corpus and an advertising corpus as training data.

For example, a text string may include “Visit Microsoft Development Website to find development resources”. Example word level n-grams may include “Visit Microsoft Development”, “Website to find”, “Development Website to”, “find development resources”, “Microsoft Development Website”, and “to find development”. Based on frequencies of occurrence of the n-grams, it may be determined that “Microsoft Development Website” occurs more frequently in the language model corpus (e.g., the language model corpus 164) than the other n-grams, and thus “Microsoft Development Website” may be provided as an advertisement title candidate.

For example, a text string may include “Visit Microsoft Development Website”, with N=3. Trigrams included in this string may include:

Vis | isi | sit | it | t M | Mi | Mic | icr | cro | ros | oso | sof |
oft | ft | t D | De | Dev | eve | vel | elo | lop | opm | pme |
men | ent | nt | t W | We | Web | ebs | bsi | sit | ite

For such n-gram models, a conditional probability may be calculated based on n-gram frequency counts. The probability of a word Wₙ, given the preceding context W₁ . . . Wₙ₋₁, may be indicated as the ratio of the number of occurrences in a training corpus of the n-gram W₁ . . . Wₙ to the total number of occurrences of any word in the same context, indicated more formally as:

$$P ( {w}_{i} \vert {w}_{i - ( n - 1 )} , ⋯ , {w}_{i - 1} ) = \frac{count ( {w}_{i - ( n - 1 )} , ⋯ , {w}_{i - 1} , {w}_{i} )}{count ( {w}_{i - ( n - 1 )} , ⋯ , {w}_{i - 1} )} \qquad ( 1 )$$

For example, n-grams may be utilized to distinguish abbreviations and misspellings.

As discussed above, the example system 600 may utilize two independent language models derived from two data corpuses: a language model web corpus (e.g., the language model corpus 164) and an advertisement corpus (e.g., the ad corpus 166). According to an example embodiment, the language model may be used to detect and provide proper grammar of an ad copy. According to an example embodiment, the advertisement corpus may be used to learn and maximize CRT and other metrics (e.g., that may be utilized by the used for rules generation).

The example off-line rules generation module of FIG. 6 may include a pattern recognition/clustering component 624 that may group advertisements based on CTR values. Common patterns may be extracted, and the rules may be generated. An ads database 626 may store the language model web corpus and the advertisement corpus. Human judgment 628 may be used to filter generated rules and patterns.

The example off-line rules generation module of FIG. 6 may be based on a combination of sets of heuristic rules and learned rules compiled into an example decision tree classification model. Generally, decision trees (or classification trees) may generate models that predict the value of a target variable based on multiple features derived from a training model. In such example decision trees, each interior node may correspond to an input feature. Edges to children for each node may represent logical “and” relations between parent and children nodes based on binary (e.g., yes or no) decisions and leaf nodes may represent classification results with metadata such as confidence scores.

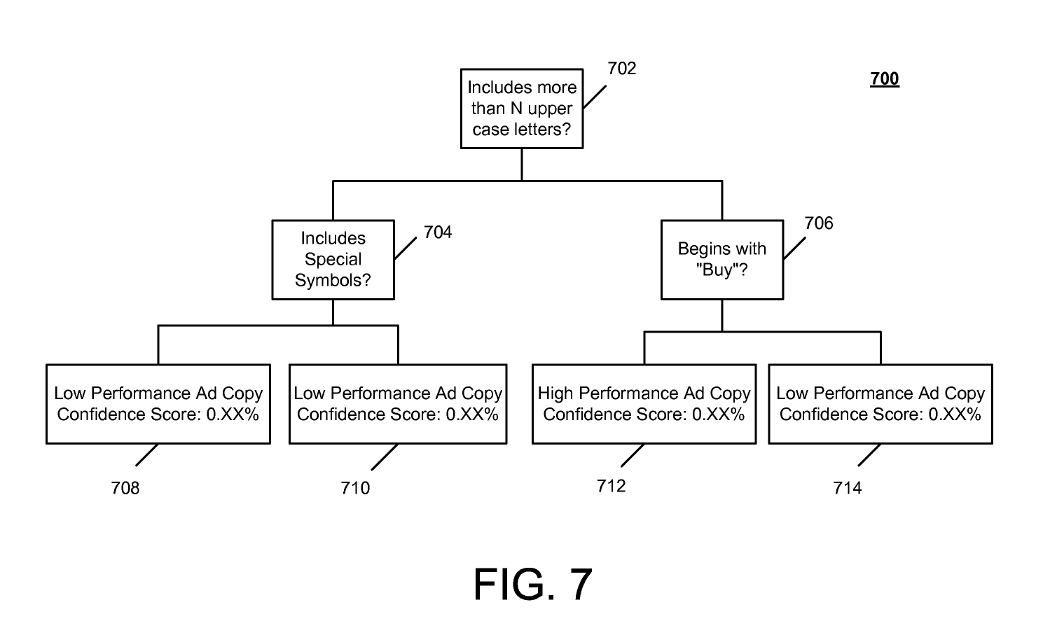

FIG. 7 depicts an example decision tree. As shown in FIG. 7, a root node 702 may correspond to an input feature “Has more than N upper case letters?”. A child node 704 may correspond to an input feature “Has Special Symbols?”, and a child node 706 may correspond to an input feature “Starts with ‘Buy’”.

As shown in FIG. 7, child nodes 708 and 710 (children of node 704) may correspond to input features “Includes more than N upper case letters?” and “Includes more than N upper case letters?”, respectively. Leaf nodes 708, 710, 712, 714 may represent classification results with metadata such as confidence scores (e.g., “Low Performance Ad Copy” or “High Performance Ad Copy”, with corresponding confidence scores).

According to an example embodiment, a combination of multiple decision trees may be used to generate an overall classification model.

According to an example embodiment, a classifier may be generated and trained based on analyzing an advertisement corpus and sorting based on advertisement CTR rates. After sorting, the top N % of the sorted ads may be utilized as a positive training set and the bottom N % may be utilized as a negative training set (e.g., N may represent a predetermined threshold value). Both training sets may be provided with features based on example n-gram techniques discussed above. Common features may then be excluded based on a Maximum Mutual Information Criterion algorithm, which may represent mutual information of two sets, indicated more formally as:

$$I ( X ; Y ) = {\sum }_{y ∈ Y} Y \vert {\sum }_{x ∈ X} X p ( x , y ) log \frac{p ( x , y )}{p ( x ) p ( y )} \qquad ( 2 )$$

where conditional probability may be determined as

$$p ( {x}_{i} , {y}_{i} ) = \frac{{x}_{i}}{\sum X} - \frac{{y}_{i}}{\sum Y} \qquad ( 3 )$$

According to an example embodiment, the classifier may be trained by applying boosted tree learning algorithms, compacted by removing unused trees and nodes, and compiled. According to an example embodiment, heuristic rules may be added or tree weights may be adjusted by human judges or experts (e.g., the human judgment 628).

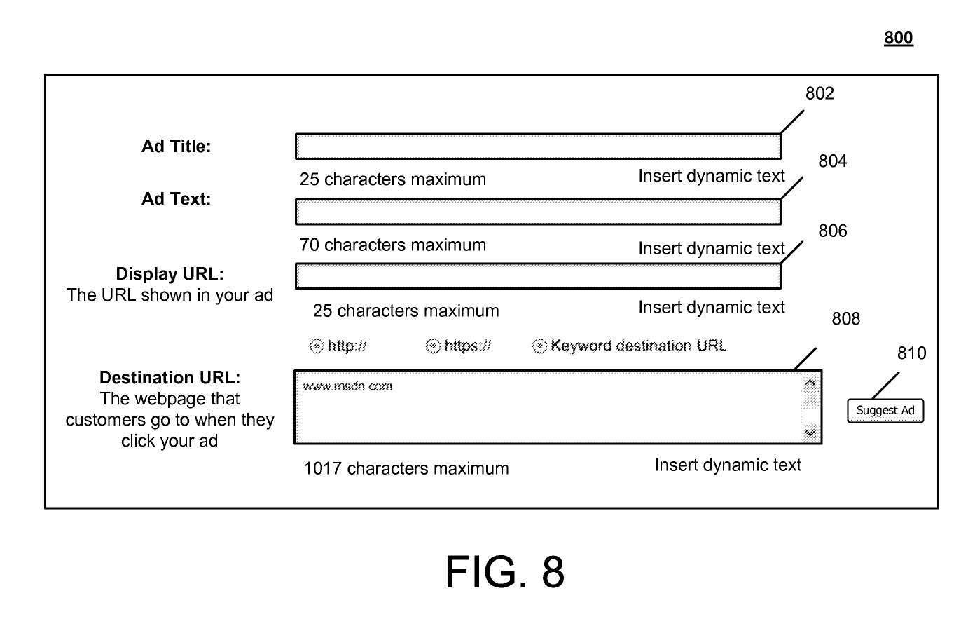

FIG. 8 depicts an example user interface 800 for user input to the system of FIG. 1. As shown in FIG. 8, an ad title 802 text box may receive an advertisement title input by a user (e.g., the user 116). An ad text 804 text box may receive an advertisement description input by a user, and a display URL 806 text block may receive a URL input by a user. For example, the URL 806 text block may receive a URL shown in the user's advertisement. A destination URL 808 text block may receive a URL associated with a web page that customers are directed to when they click on the user's advertisement. A “suggest ad” button 810 may be activated by the user when the input is complete, and ready for submission to the system of FIG. 1. According to an example embodiment, other text such as negative keywords, may also be input. According to an example embodiment, other web page objects such as audio files and/or image files may also be input.

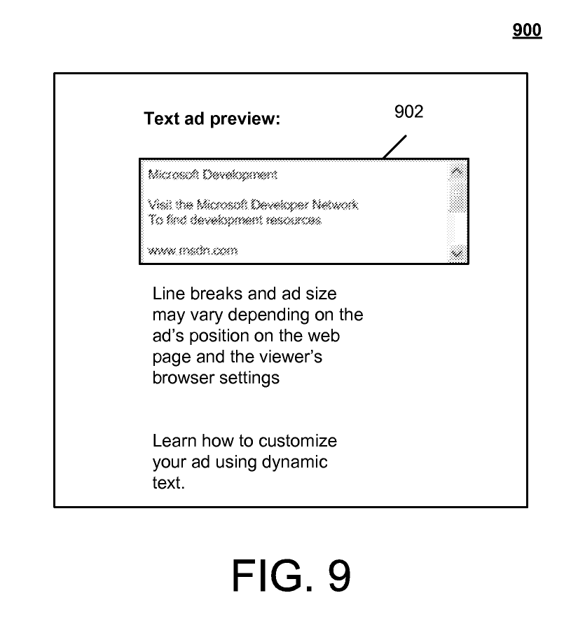

FIG. 9 depicts an example user interface 900 for displaying advertisement previews to the user. As shown in FIG. 9, an ad preview 902 text box may display an advertisement generated by the system 100 of FIG. 1. As shown in FIG. 9, a URL input by the user via the user interface of FIG. 8 may be included in the advertisement for clicking by potential customers. According to an example embodiment, each click made by customers on advertisements may add to CTR counts in a database that includes an advertisement corpus.

Example techniques discussed herein may thus provide advertisements that may be auto-generated based on a user input of a location identifier associated with a web page that is associated with the user.

Customer privacy and confidentiality have been ongoing considerations in online environments for many years. Thus, example techniques for determining advertisement content may use data provided by users having an intent to post information publicly, and may thus avoid accessing data that may be personal to particular users.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine usable or machine readable storage device (e.g., a magnetic or digital medium such as a Universal Serial Bus (USB) storage device, a tape, hard disk drive, compact disk, digital video disk (DVD), etc.) or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand alone program or as a module, component, subroutine, or other unit suitable for use in a computing environment. A computer program that might implement the techniques discussed above may be deployed to be executed on one computer or on multiple computers at one site or distributed across multiple sites and interconnected by a communication network.

Method steps may be performed by one or more programmable processors executing a computer program to perform functions by operating on input data and generating output. The one or more programmable processors may execute instructions in parallel, and/or may be arranged in a distributed configuration for distributed processing. Method steps also may be performed by, and an apparatus may be implemented as, special purpose logic circuitry, e.g., an FPGA. (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back end component, e.g., as a data server, or that includes a middleware component, e.g., an application server, or that includes a front end component, e.g., a client computer having a graphical user interface or a Web browser through which a user can interact with an implementation, or any combination of such back end, middleware, or front end components. Components may be interconnected by any form or medium of digital data communication, e.g., a communication network. Examples of communication networks include a local area network (LAN) and a wide area network (WAN), e.g., the Internet.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system comprising:
a document acquisition component that obtains one or more web page documents;
a page parsing component that extracts display text from the obtained one or more web page documents; and
an advertisement candidate generator component that generates, via a device processor, one or more candidate advertisements based on the extracted display text, based on an analysis of language model attributes and historical advertising success attributes associated with the extracted display text.

2. The system of claim 1, further comprising:
a user input acquisition component that obtains input from a user, wherein:
the advertisement candidate generator component generates the one or more candidate advertisements based on the extracted display text and the obtained input from the user, based on an analysis of language model attributes and historical advertising success attributes associated with the extracted display text and the obtained input from the user.

3. The system of claim 1, wherein:
the page parsing component extracts display text from the obtained one or more web page documents based on a web page formatting structure, and based on determining one or more text relevance weight values based on the web page formatting structure associated with the obtained one or more web page documents, wherein:
the advertisement candidate generator component generates the one or more candidate advertisements based on the extracted display text, based at least in part on the one or more text relevance weight values, wherein:
the web page formatting structure includes one or more of HyperText Markup Language (HTML) or eXtensible Markup Language (XML) formatting.

4. The system of claim 1, wherein:
the advertisement candidate generator component includes:
an advertisement title component that determines one or more candidate titles for advertisements based on the extracted display text;
an advertisement description component that determines one or more candidate description bodies for advertisements based on the extracted display text, and
an advertisement candidate ranking component that determines a ranking order of pairs of the candidate titles and candidate description bodies, based on a ranking analysis of language model attributes and historical advertising success attributes associated with text included in the pairs of candidate titles and candidate description bodies.

5. A method comprising:
obtaining one or more target web page documents that include web page content;
determining text content associated with the web page content; and
generating, via a device processor, one or more candidate web advertisements based on an analysis of the determined text content.

6. The method of claim 5, further comprising:
determining one or more independent phrases included in the determined text content, wherein:
generating the one or more candidate web advertisements includes generating, via the device processor, the one or more candidate web advertisements based on an analysis of the independent phrases.

7. The method of claim 5, further comprising:
determining a plurality of n-grams included in the determined text content, wherein:
generating the one or more candidate web advertisements includes generating, via the device processor, the one or more candidate web advertisements based on an analysis of the plurality of n-grams.

8. The method of claim 5, wherein:
the analysis of the determined text content includes an analysis of histories of occurrences of n-grams included in a first corpus associated with a language model and a second corpus associated with a crawled collection of web advertisements.

9. The method of claim 5, wherein:
the analysis of the determined text content includes an analysis of one or more quality scores associated with ad copy text and an analysis of text strings that are synonymous with one or more n-grams included in the determined text content.

10. The method of claim 9, wherein:
the analysis of the text strings that are synonymous with the one or more n-grams included in the determined text content includes an analysis to determine whether the synonymous text strings include one or more of:
a shorter character length than a character length of the associated synonymous n-grams,
a higher grammatical quality score than the associated synonymous n-grams based on a language model analysis, or
a higher CTR value than the associated synonymous n-grams based on an advertisement text corpus analysis.

11. The method of claim 5, further comprising:
determining one or more geographic locations associated with the determined text content, wherein:
generating the one or more candidate web advertisements includes generating, via the device processor, the one or more candidate web advertisements based on an analysis of the one or more geographic locations.

12. The method of claim 5, wherein:
the analysis of the determined text content includes an analysis of one or more quality scores associated with ad copy text and one or more click-through rate (CTR) values associated with a web page object or one or more text strings.

13. The method of claim 12, wherein:
the one or more CTR values associated with the web page object or the one or more text strings include CTR values associated with a search key value and an advertisement associated with the search key value, wherein the CTR value indicates a probability that the advertisement receives a click from a user that provides the search key value for a search operation.

14. The method of claim 5, further comprising:
obtaining input from a user, wherein:
generating the one or more candidate web advertisements includes generating, via the device processor, the one or more candidate web advertisements based on an analysis of the determined text content and the input obtained from the user.

15. The method of claim 14, wherein:
the input obtained from the user includes a location indicator associated with the one or more target web page documents, the location indicator including one or more of a Uniform Resource Locator (URL) or an Internet Protocol (IP) address, wherein:
obtaining the one or more target web page documents includes initiating a fetch of the target one or more target web page documents based on the location indicator included in the obtained input.

16. The method of claim 14, wherein the input obtained from the user includes one or more of:
an indication of an image file,
an indication of an audio file,
an advertisement keyword, or
a negative advertisement keyword.

17. The method of claim 14, wherein:
the input obtained from the user includes one or more of an advertisement title keyword suggestion or an advertisement content keyword suggestion.

18. A computer program product tangibly embodied on a computer-readable storage medium and including executable code that causes at least one data processing apparatus to:
obtain a location indicator associated with one or more target web page documents that include web page content;
initiate, via a device processor, a request for one or more candidate web advertisements based on an analysis of the web page content included in the one or more target web page documents; and
initiate a display of the one or more candidate web advertisements.

19. The computer program product of claim 18, wherein:
the location indicator includes one or more of a Uniform Resource Locator (URL) or an Internet Protocol (IP) address.

20. The computer program product of claim 18, wherein the executable code is configured to cause the at least one data processing apparatus to:
obtain input from a user, wherein:
initiating, via the device processor, the request for the one or more candidate web advertisements includes initiating, via the device processor, the request for one or more candidate web advertisements based on an analysis of the web page content and the input obtained from the user.
